(19) United States
(12) Patent Application Publication
(10) Pub. No.: US 2015/0277065 A1
(43) Pub. Date: Oct. 1, 2015

(54) Optical fiber source and repeaters using tapered core waveguides

(71) Applicant: SOLARSORT TECHNOLOGIES, INC, Barrington, RI (US)

(72) Inventors: Shalom Wertsberger, Rochester, NY (US); Shalom Wertsberger, Rochester, NY (US)

(73) Assignee: Shalom Wertsberger, Rochester, NY (US)

(21) Appl. No.: 14/426,943

(22) PCT Filed: Sep. 13, 2013
(86) PCT No.: PCT/US13/59634

§ 371 Date: Mar. 9, 2015

Related U.S. Application Data
(63) Continuation-in-part of application No. 13/831,575, filed on Mar. 14, 2013, now Pat. No. 9,112,087.
Application No. 13/831,575 is a continuation-in-part of application No. 13/685,691, filed on Nov. 26, 2012, now Pat. No. 8,530,825.
(60) Provisional application No. 61/701,687, filed on Sep. 16, 2012.
(60) Provisional application No. 61/713,602, filed on Oct. 14, 2012.
(60) Provisional application No. 61/718,181, filed on Oct. 24, 2012.
(60) Provisional application No. 61/723,773, filed on Nov. 7, 2012.
(60) Provisional application No. 61/723,832, filed on Nov. 8, 2012.
(60) Provisional application No. 61/724,920, filed on Nov. 10, 2012.
(60) Provisional application No. 61/801,619, filed on Mar. 15, 2013.
(60) Provisional application No. 61/801,431, filed on Mar. 15, 2013.
(60) Provisional application No. 61/786,357, filed on Mar. 15, 2013.
(60) Provisional application No. 61/701,687, filed on Sep. 16, 2012.
(60) Provisional application No. 61/713,602, filed on Oct. 14, 2012.
(60) Provisional application No. 61/718,181, filed on Oct. 24, 2012.
(60) Provisional application No. 61/723,832, filed on Nov. 8, 2012.
(60) Provisional application No. 61/723,773, filed on Nov. 7, 2012.
(60) Provisional application No. 61/724,920, filed on Nov. 10, 2012.
(60) Provisional application No. 61/701,687, filed on Sep. 16, 2012.
(60) Provisional application No. 61/713,602, filed on Oct. 14, 2012.

(30) Foreign Application Priority Data
Dec. 14, 2012 (GB) 1222557.9

(51) Int. Cl. G02B 6/42

(52) U.S. Cl. CPC G02B 6/4203

(57) ABSTRACT

An optical fiber interface devices and repeaters are provided. The devices utilized a tapered core waveguide with cladding disposed thereabout, the core having an aperture at the wider end of the taper. At least one transducer is disposed about the cladding. Energy coupled from the transducer into the cladding is coupled into the fiber in transmitting embodiment, and energy coming from the fiber is coupled to the transducer in receiving embodiment. The interface may act as a multiplexer and/or demultiplexer. A repeater comprises a receiving and a transmitting embodiment. Optionally the devices are able to harvest energy transmitted via the fiber.

### RELATED APPLICATIONS

Aspects of the present invention were first disclosed in U.S. Patent Application 61/701,687 to Andle and Wertsberger, entitled “Continuous Resonant Trap Refractor, Waveguide Based Energy Detectors, Energy Conversion Cells, and Display Panels Using Same”, filed 16 Sep. 2012. Further refinements of the tapered waveguide based Continuous Resonant Trap Refractor (CRTR) and to lateral waveguides with which CRTRs may cooperate, were disclosed together with various practical applications thereof in the following additional U.S. patent applications: 61/713,602, entitled “Image Array Sensor”, filed 14 Oct. 2012; 61/718,181, entitled “Nano-Scale Continuous Resonance Trap Refractor”, filed 24 Oct. 2012; 61/723,832, entitled “Pixel Structure Using Tapered Light Waveguides, Displays, Display Panels, and Devices Using Same”, filed 8 Nov. 2012; 61/723,773, entitled “Optical Structure for Banknote Authentication”, filed 7 Nov. 2012; Ser. No. 13/726,044 entitled “Pixel Structure Using Tapered Light Waveguides, Displays, Display Panels, and Devices Using Same”, filed 22 Dec. 2012; Ser. No. 13/685,691 entitled “Pixel structure and Image Array Sensors Using Same”, filed 26 Nov. 2012; Ser. No. 13/831,575 entitled “Waveguide Based Energy Converters, and energy conversion cells using same” filed Mar. 15, 2013; 61/786,357 titled “Methods of Manufacturing of Continuous Resonant Trap Structures, Supporting Structures Thereof, and Devices Using Same” filed Mar. 15, 2013, 61/801,619 titled “Tapered Waveguide for Separating and Combining Spectral Components of Electromagnetic Waves” filed Mar. 15, 2013, U.S. 61/801,431 titled “Continues Resonant Trap Refractors, lateral waveguides, and devices using same” filed Mar. 15, 2013, all to Andle and Wertsberger; and 61/724,920, entitled “Optical Structure for Banknote Authentication, and Optical Key Arrangement for Activation Signal Responsive to Special Light Characteristics”, filed 10 Nov. 2012, to Wertsberger. Furthermore Patent application GB 1222557.9 filed Dec. 14, 2013 claims priority from U.S. 61/701,687. All of the above-identified patent applications are hereby incorporated herein by reference in their entireties.

### FIELD OF THE INVENTION

The present invention relates generally to optical nanostructures and telecommunication devices using the same, and more particularly to devices for refracting and spatially separating, or combining, radiant energy and devices using same in conjunction with electrical to radiant energy inter-transducers.

### BACKGROUND

The telecommunication field is wide and varied, but almost all of it shows insatiable need for speed and bandwidth, and in most cases, also for reduced error rates. Optical fiber networks are the norm and are utilized from the international backbone to local residences. However the signals in a fiber network require specialized equipment.

Optical fiber transmitters convert electrical signals to radiant energy and couple the radiant energy to the fiber. Most optical fiber transmitters today employ laser technology, with a minority utilizing Light Emitting Diodes (LED). An optical fiber transmitter must meet two seemingly contradicting requirements: it should generate a signal of sufficient magnitude for the signal to enable the receiver on the other end of the fiber to decode the signal and transform it back to electrical signal. However injecting too much power to an optical fiber may cause non-linear effects within the fiber, and may also saturate the receiver, causing lose of data. Further requirement relate to dispersion-radiant energy of differing frequencies travel at slightly differing speeds along the fiber, and is attenuated at different rates. This causes gradual spreading of the signal, as a function of the distance traveled within the fiber. Differing polarization, absorption by the fiber and the cladding, and other factors all also causes signals to become more convoluted, and limit the range of transmittal in optical fibers. Repeaters are used for regenerating the optical fiber signal, however powering such repeaters may be expensive.

In its most basic form, the term ‘refraction’ means the change of direction of a ray of light, sound, heat, radio waves, and other forms of wave energy, as it passes from one medium to another. Generally waves of different frequencies would refract at different angles and thus refraction tends to spatially separate multispectral radiation into its component frequencies.

Radiant energy used in communication extends over a very broad spectrum, but is most commonly confined to the infra red arena. However different aspects of the invention may be applicable to ranges from the Ultra Violet (UV), via the visible light portion of the spectrum, to Infra Red (IR). Many applications would need to cover only portions of this spectrum. It is seen therefore that the application at hand determines the spectral range of interest, and that a spectral range of interest may differ by application, an apparatus, or a portion thereof. Regarding lateral waveguides, yet another aspect described below, each waveguide may have its own spectrum of interest, which may differ from the spectral range of interest of an adjacent waveguide, while the waveguides as a whole may have a different spectral range of interest. Therefore, the spectral range of interest is defined herein as relating to any portion or portions of the total available spectrum of frequencies which is being utilized by the application, apparatus, and/or portion thereof, at hand, and which is desired to be detected and/or emitted utilizing the technologies, apparatuses, and/or methods of the invention(s) described herein, or their equivalents.

Structure to facilitate conversion of radiant energy to electricity or electrical signals (hereinafter “LE”), or conversion of electrical signals into radiant energy such as light (hereinafter “EL”) are known. Collectively, objects, materials, and structures, which perform conversion between two forms of energy, or adjust and control flow of energy, are known by various names which denote equivalent structures, such as converters, transducers, absorbers, detectors, sensors, and the like. To increase clarity, such structures will be referred to hereinunder as ‘transducers’. By way of non-limiting examples, the term “transducer” relates to light sources, light emitters, light modulators, light reflectors, laser sources, materials including organic and inorganic transducers, CCD and CMOS structures, LEDs, OLEDs, LCDs, receiving and/or transmitting antennas and/or rectennas, phototransistors photodiodes, diodes, electroluminescent devices, fluorescent devices, gas discharge devices, electrochemical transducers, and the like.

The skilled in the art would recognize that certain LE transducers may act as EL transducers, and vice versa, with proper material selection, so a single transducer may operate both as EL and LE transducer, depending on the manner of operation. Alternatively transducers may be built to operate only as LE or as EL transducers. Furthermore, different types of transducers may be employed in any desired combination, so the term transducers may imply any combinations of LE and EL, as required by the application at hand.

Waveguides are a known structure for trapping and guiding electromagnetic energy along a predetermined path. While optical fibers are perhaps the most well known waveguide, other waveguides abound, and the present invention utilizes such. An efficient waveguide may be formed by locating a layer of dielectric or semiconducting material between cladding layers on opposite sides thereof, or surrounding it. The cladding may comprise dielectric material or conductors, commonly metal. Waveguides have a cutoff frequency, which is dictated by the wavelength in the waveguide materials, and the waveguide width. As the frequency of the energy propagating in the waveguide approaches the cutoff frequency Fc, the energy propagation speed along the waveguide is slowed down. The energy propagation of a wave along a waveguide may be considered as having an angle relative to cladding. This angle is determined by the relationship between the wavelength of the wave and the waveguide width in the dimension in with the wave is being guided. If the width of the waveguide equals one half of the wave wavelength, the wave reaches resonance, and the energy propagation along the waveguide propagation axis stops. The condition where energy is at or close to such resonance will be termed as a stationary resonant condition.

Tapered waveguide directed at trapping radiant energy, as opposed to emitting energy via the cladding, have been disclosed by Min Seok Jang and Harry Atwater in “Plasmionic Rainbow Trapping Structures for Light localization and Spectrum Splitting” (Physical Review Letters, RPL 107, 207401 (2011), 11 Nov. 2011, American Physical Society©). The article “Visible-band dispersion by a tapered air-core Bragg waveguide”, (B. Drobot, A. Melnyk, M. Zhang, T. W. Allen, and R. G. DeCorby, 8 Oct. 2012/Vol. 20, No. 21/OPTICS EXPRESS 23906, ©2012 Optical Society of America_{—} “Visible-band dispersion by a tapered air-core Bragg waveguide” B. Drobot, A. Melnyk, M. Zhang, T. W. Allen, and R. G. DeCorby, 8 Oct. 2012/Vol. 20, No. 21/OPTICS EXPRESS 23906, ©2012 Optical Society of America) describes out-coupling of visible band light from a tapered hollow waveguide with TiO2/SiO2 Bragg mirrors. The mirrors exhibit an omnidirectional band for TE-polarized modes in the ˜490 to 570 nm wavelength range, resulting in near-vertical radiation at mode cutoff positions. Since cutoff is wavelength-dependent, white light is spatially dispersed by the taper. These tapers can potentially form the basis for compact micro-spectrometers in lab-on-a-chip and optofluidic micro-systems. Notably, Bragg mirrors are very frequency selective, complex to manufacture, and require at least a width higher than ¾ wavelength to provide any breadth of spectrum. In addition to the very narrow band, the Bragg mirrors dictate a narrow bandwidth with specific polarization, while providing however a fine spectral resolution.

A Continuous Resonant Trap Refractor (CRTR) is the name used in these specification to denote a novel structure which is utilized in many aspects of the present invention. As such, a simple explanation of the principles behind its operation is appropriate at this early stage in these specifications, while further features are disclosed below.

A simplified view of a CRTR operating in splitter mode is provided in FIG. 1. A CRTR 71 is a structure based on a waveguide having a tapered core 73, the core having a wide base face Hₘₐₓ forming an aperture, and a narrower tip Hₘᵢₙ which may narrow taper to a point, or any other desired shape (not shown in FIG. 1). The core is surrounded at least partially by a cladding 710 which is transmissive of radiant energy under certain conditions. The axis X-X extending between the aperture and the tip is the CRTR depth axis, which increases in a direction from the aperture towards the tip. The CRTR may be operated in splitter mode, in a mixer/combiner mode, in reflective mode, or in a hybrid mode providing combination of the other modes. In splitter mode the radiant energy 730 wave is admitted into the CRTR via the aperture, and travels along the depth direction. The width of a two dimensional CRTR is transverse to the depth direction, while for a three dimensional CRTR, at any depth the CRTR has a plurality of widths transverse to the depth direction. The different widths for a single depth form a width plane, which is transverse to the depth direction, and the term ‘in at least one direction’ as related to CRTR width, relate to directions on the width plane or parallel thereto. Any given depth correspond with its width plane, and thus there are infinite number of parallel width planes. The tapered core width varies in magnitude so as to be greater at the first end than at the second end in at least one width dimension.

The tapered core is dimensioned such that in splitter and reflective modes at least some of the admitted spectral components will reach a state where they will penetrate the cladding, and be emitted therefrom. This state is referred to as Cladding Penetration State (CPS), and is reached when energy of a certain frequency approaches a critical width of the waveguide for that frequency. The mechanism at which cladding penetration state occurs may vary, such as by tunneling penetration, skin depth penetration, a critical angle of incidence with the cladding and the like. Generally CPS will occur in proximity to or at the width, where the wave reaches a resonance, known as the critical frequency for that width, and conversely at the critical width for the frequency of the wave. Regardless of the mechanism, a CPS is characterized by the wave reaching a frequency dependent depth within the CRTR where it is emitted via the cladding. The decreasing width of the core will dictate that a lower frequency wave will reach CPS before higher frequency waves, and will penetrate the cladding and exit the waveguide at a shallower depth than at least one higher frequency wave. As waves of differing frequencies will be emitted via the cladding at differing depths, the CRTR will provide spatially separated spectrum along its cladding. Notably, in certain CRTR embodiments some frequency components of the incoming energy may be emitted via the tip, in non-sorted fashion.

The size Hₘₐₓ limits the lowest cutoff frequency Fₘᵢₙ. At the tip the tapered core width Hₘᵢₙ dictate a higher cutoff frequency Fmax. Between the aperture wide inlet and the narrower tip, the cutoff frequency is continually increased due to the reduced width. Waves having a lower frequency than the cutoff frequency Fmin are reflected 735. Waves 740 having frequency higher than Fₘₐₓ exit through the CRTR core, if an exit exists. Waves having frequencies between Fₘᵢₙ and Fₘₐₓ will reach their emission width, and thus their cladding penetration state, at some distance (emission width) from the inlet of the waveguide depending on their frequency.

Thus, examining the behavior of a wave of arbitrary frequency Fₜ, where Fₘᵢₙ<Fₜ<Fₘₐₓ, which enters into the CRTR core at its aperture at an incidence angle within an acceptance cone centered about the propagation axis X-X, the angle θ between the wave and X-X will vary as the wave propagates along the X-X axis due to the narrowing of the CRTR waveguide and increase of the cutoff frequency, as depicted schematically by Ft′. As the wave approaches depth X(Fₜ) where either the tapered waveguide cutoff frequency equals or nearly equals Fₜ, or the angle θ approaches the critical angle θ_{C}, at which the wave can not propagate any further within the CRTR core. The wave Fₜ is thus either radiated through the dielectric cladding of the CRTR as shown symbolically by 750, or is trapped in resonance at depth X(Fₜ) in a thin metal clad CRTR, and is emitted through the cladding at that depth, as shown by 752. At that point 750 or 752 the wave of frequency Ft reached its cladding penetration state at the emission depth dictated by the emission width of the tapered CRTR core. For a continuum of entering waves of different frequencies Fₘᵢₙ<F₁, F₂, . . . Fₓ<Fₘₐₓ, entering the aperture. The tapered core waveguide becomes a Continuous Resonant Trap Refractor (CRTR) in which the different frequency waves become standing waves, trapped at resonance along the X-X axis in accordance to their frequency. Such trapped waves are either leaked through the cladding by the finite probability of tunneling though the cladding or are lost to absorption in the waveguide. Note that a CRTR will also cause admitted rays to be refracted or otherwise redirected so that the component(s) produced by splitting exit the CRTR at an angle to the CRTR depth axis. This will make it possible to employ a CRTR that has been embedded within stacked waveguides in such a manner that the CRTR directs spectral components of the incoming multispectral radiation to predetermined waveguides.

Conversely, when operated in mixer/combiner mode, a wave coupled to the core via the cladding at or slightly above a depth where it would have reached CPS in splitter mode, will travel from the emission depth towards the aperture, and different spectral components coupled to the core through the cladding will be mixed and emitted through the aperture. Coupling light into the CRTR core from the cladding, will be referred to as ‘injecting’ or ‘inserting’ energy into the CRTR. The depth at which the wave would couple into the tapered core is somewhat imprecise, as at the exact depth of CPS the wave may not couple best into the core. Thus the term ‘slightly above’ as referred to the coupling of light into the tapered core in combiner/mixer mode should be construed as the depth at which energy injected into the tapered core via the cladding would best couple thereto to be emitted via the aperture, within certain tolerances stemming from manufacture considerations, precision, engineering choices and the like.

Thus functionally, a CRTR is a device which allows passage of radiant energy therethrough, while
a. imparting a change in the direction of propagation of incoming energy;
b. in one mode a CRTR is operational to spatially disperses incoming energy into spatially separated spectral components thereof, which are outputted via the CRTR cladding, the mode is equivalently referred to as disperser, splitter, or dispersion mode;
c. in another mode a CRTR is operational to combine a plurality of incoming spectral components into emitted energy comprising the components and emitted via the aperture, the mode equivalently referred to as combiner, mixer, or mixing mode; and,
d. in another mode the CRTR is operational to controllably reflect at least a portion of the spectral components admitted via the aperture, the reflected components being reflected via the aperture, thus controllable changing the effective reflectance of the CRTR at selected spectral components, the mode equivalently referred to as reflective mode or reflectance mode.

A CRTR is considered to operate in hybrid mode when energy is both admitted and emitted via the aperture. In certain embodiment this mode involves energy being admitted via the aperture and at least portions thereof being emitted via the cladding or being selectively reflected, while other energy is being injected via the cladding and emitted via the aperture.

It is noted that CRTR use may extend to the millimeter wave range (EHF), or even to the microwave range. Depending on where between cm waves and micron IR the range of dielectric constants available increases dramatically. By way of example, water has an index of refraction of nearly 10 at radio frequencies but only 1.5 at IR to UV. There are numerous optical materials with low and high index at mm wave frequencies and below. Thus while the principles of operation of CRTRs are similar, the materials and sizes differ. A millimeter/microwave operated CRTR is a channelized filter integrated into a horn antenna wherein the channelized ports are lateral to the horn and the in-line exit port is a high pass filtered output for a broad band input. Such device may be utilized as a an excellent front end for a multiplexer/diplexer.

CRTRs are often disposed within a stratum. In some embodiments stratums comprise a plurality of superposed waveguides equivalently referred to as superposed waveguides, stacked waveguides, or lateral waveguides. In other embodiments the stratum comprises a slab of material that is transmissive of the radiant energy spectral range of interest. The CRTRs are disposed such that the CRTR depth direction is substantially perpendicular to the local plane of the stratum. Radiant energy emitted from the cladding is coupled to transducers within the stratum or via the stratum, and radiant energy trom EL transducers within the stratum is coupled to the CRTR via the cladding.

In many embodiments that utilize lateral waveguide based stratum, transducers are embedded within the lateral waveguide. In certain embodiments the transducers are optimized for the frequency which is in the spectral range to which the corresponding waveguide is exposed. Conversely in certain embodiments the dimensions of the lateral waveguide is optimized for a transducer which emits energy of a certain frequency, however those are not requirements to many of the aspects of the present invention.

CRTRs are capable of providing a hyperspectral or multi-spectral pixels, which may be arranged in arrays. Those pixels act as a reversible channelized filter of light and other radiant energy, capable of operating from the long IR—and even to the millimeter wave radar and microwave regimes of the electromagnetic spectrum—to the deep UV. CRTRs are further capable of energy harvesting, as the channelized outputs are converted to electrical energy using photovoltaic and related processes.

CRTR based sensing pixels (generally referred to hereinafter as sensing pixels) utilize the CRTR or a portion thereof in splitter mode, to admit radiant energy via the aperture, and selectively channel portions of the admitted spectrum into frequency dependent locations, where the incoming energy may be converted into electrical energy by a one or more LE transducers, the ordered outputs of which correspond to an image portion sensed by the pixel. Thus the sensing pixel is a combination of a CRTR and at least one EL transducer. Optionally a sensing pixel may also harvest some or all of the incoming energy for powering related circuitry, and/or emit energy.

CRTR based emitting pixels (generally referred to herein as emitting pixels) utilize the CRTR or portion thereof in mixer/combiner mode, to receive energy of varying spectral components via the cladding. The CRTR or a portion thereof is operated in mixer/combiner mode, wherein an array of weighted radiant energy sources serve as channelized inputs. Spectral components from the energy sources are fed into the CRTR core via the cladding, and are combined to emit the combined energy via the aperture, the spectral details of which are determined by the weighting of the spectral components of the energy sources. Different spectral components injected into the cladding will mix. Thus, by way of example, light of frequency Fr, injected through the cladding into the tapered waveguide core, will mix with the light of Fp. Therefore, assuming that the core material is equally transparent to components of the CRTR spectral range of interest, and that the optical loses in the core are negligible, the radiant energy emitted from the CRTR aperture would be the summation of the radiant energy injected into the core.

The path which a spectral component takes between the CRTR and its respective transducer constitute the channel. Channels may take many forms, such as lateral waveguides, paths within a slab stratum, other waveguides, and the like. A channel may also constitute a path between the CRTR core and a RL transducer even if such path is of minute length. In certain application the channel may be to an absorber which absorb the energy for storage, dispensing, as heat, and the like.

### SUMMARY

Different aspects of the present invention utilize different capabilities of CRTRs, which may be operated as a multispectral capable photonic pixel which is capable of acting as a reversible channelized filter/combiner, capable of operating from the far IR and mm wave radar regime of the electromagnetic spectrum, to the deep Ultra Violet (UV) range. As such it is an object of the invention to provide CRTR based devices and systems to improve telecommunication devices such as optical fiber transmitters and receivers, optical fiber repeaters, delivery of power via optical fibers, and the like.

In order to simplify the description of different aspects of the invention embodying devices using CRTRs, FIG. 2 provides schematic symbols for the modes of operation of the different modes in which the CRTRs operate at least a portion of the time. FIG. 2(a) represent a generic symbol for a CRTR operating at any mode, and also shows schematically how lateral waveguides 210 are disposed relative to the CRTR core and cladding. FIG. 2(b) symbolically represents a CRTR operating as a refractor, also known as a disperser, or splitter, mode. FIG. 2(c) represents a CRTR operating in combiner mode, also known as a mixer mode, and FIG. 2(d) represents to a CRTR in mixed or hybrid mode, where the CRTR receives energy through the aperture and spatially separates it to spectral components and which receives energy via the cladding and combines and emits it via the aperture. Hybrid operation can be achieved by judicious selection of transducers disposed about the CRTR.

Notably, CRTR's may be deployed in combinations with lenses, collimators, and the like.

In some embodiments, the CRTR is embedded in a stack of lateral waveguides, each containing transducers, or acting as energy guides to transducers. The transducers may be optimized to the type of radiant energy received.

The design of the aperture diameter (typically between λ′max/2 and ˜λ′max, but optionally larger) and CRTR array spacing may be selected to optimize optical collection efficiency, pixel size, and/or angle of acceptance. The larger the diameter, the narrower the main diffraction lobe of the CRTR's acceptance pattern is; however, the larger the effective pixel spacing. The CRTR tapers to approximately half the wavelength of the shortest wave in the spectral range of interest, λ′min/2. Energy at shorter wavelengths is either absorbed, reflected, or passed through the CRTR. The dimensions are in wavelengths adjusted for the refractive index of the core material (λ′=λcore). The core material is highly transparent over the entire band. Oftentimes in applications requiring interface with optical fibers, the dimensions of the optical fiber and ease of alignment may be a factor for consideration when dimensioning the CRTR aperture, or an aligner structure.

CRTRs operating in splitter mode operate to detect or harvest radiant energy, and convert it to electrical energy. When operated in mixer/combiner mode, CRTR based pixels may also be utilized as energy emitting sources. Notably, the CRTR may be operated in a combination of different modes, thus, by way of example, a CRTR may have one LE transducer disposed to receive a certain spectral component and transform it to an electrical signal corresponding to the spectral component, while a second LE transducer may be disposed about the same CRTR but at another location and be operational to harvest the energy of another spectral component. The harvested energy may be used for any desired purpose, including powering other aspects of the device, or for retransmission. An EL transducer may further be disposed, such that energy emitted therefrom will be coupled to the core via the cladding, and emitted via the aperture. Thus, a single CRTR based pixel may by way of example act as a pixel for sensing incoming light on several frequencies, harvest energy of another spectral component, and transmit a signal via the aperture. Pixel operating in more than one mode, will be considered as operating in both modes, and thus the pixel described above should be considered as an emitting pixel, and a sensing pixel (also known as harvesting pixel), and the pixel may do all or part of those actions at the same time, or sequentially.

Therefore in a basic embodiment of the invention there is provided a CRTR based pixel, which comprises a tapered waveguide core having a first end and a second end, the first end defining an aperture, the core having a depth direction extending between the first end and the second end, wherein the depth magnitude increases with distance from the first end toward the second end; the core having a monotonically decreasing width dimension in at least one direction transverse to the depth direction. A cladding is disposed at least partially around the core. To form a pixel, at least one transducer is coupled to the CRTR by being disposed about the cladding. The transducer may be disposed about the cladding by being positioned at least in part within the cladding, but more commonly being positioned near the cladding, or having a predetermined path by which energy emitted from the cladding will impinge on the transducer. Oftentimes the transducer will be disposed in a lateral waveguide in which the CRTR is embedded. The transducer may be a LE or an EL type. When the transducer is a LE type transducer, it converts spectral components of radiant energy admitted into the aperture into electrical energy, in which case the pixel is a sensing pixel. When the transducer is an EL transducer which converts electrical energy into radiant energy to be injected into the tapered core and at least partially emitted via the aperture, the pixel forms an emitting pixel. When a pixel has at least two converters each being of different type, or when one transducer may be operated as more than one type, the pixel is considered to be a hybrid pixel. A hybrid pixel encompasses therein the two types of pixels dictated by the type of transducer or transducers.

The term “about the cladding” should be construed to mean being coupled to via energy path, which implies that the transducer is disposed about the cladding not only by being physically adjacent to the cladding, but also when an energy path such as beam propagation, waveguide, and the like, exists between the location where energy is transferred in or out of the cladding, and the transducer. Similarly, the disposition about the cladding is set by the location at which the energy exists or enters the cladding. Thus, by way of example if the transducer is coupled to the cladding via a waveguide such that the energy couples at depth A of the CRTR, the transducer is considered to be disposed at depth A.

Two aspects of the invention are specifically advantageous for optical fiber communications. A optical fiber interface is provided, for coupling electrical signals to and/or from an optical fiber. The transmitting interface comprises an emitting pixel having at least one EL transducer, and an aligner disposed for aligning the optical fiber with the aperture of the pixel wherein the at least one transducer is a laser transducer. Similarly, the receiving interface comprises a sensing pixel and an aligner disposed for aligning the optical fiber with the aperture of the pixel. In some embodiments the pixel may be a hybrid pixel operating in emitting and sensing pixel modes, and such bidirectional operation may be considered as a single interface which is a combination of transmitting and receiving optical fiber interfaces. Optionally, the tapered core of the pixel has a depression formed therein, for ease of alignment and interfacing between the fiber and the tapered CRTR core within the pixel, and in such cases the depression may be the aligner or form a portion thereof. In some embodiments the aligner is incorporated with tapered core while in others the aligner is a separate entity. Optionally, the aligner may be a portion of an enclosure containing the optical fiber interface. The aligner may also be formed of moldable or hardenable material such as epoxy, thermoset, or other material which may be utilized to attach the fiber to the CRTR tapered core.

Another aspect which is especially advantageous for the communication field provides an optical fiber signal repeater comprising at least one sensing pixel having at least one LE transducer, at least one emitting pixel having at least one EL transducer, and a signal regeneration circuitry coupled between the at least one LE transducer in the sensing pixel and to the at least one EL transducer in the emitting pixel.

Optionally the optical fiber repeater further comprises a power supply circuit, which may be powered by a power harvesting arrangement for receiving power harvested from an optical fiber. The power delivered in one of the fibers as radiant energy is harvested and is used to operate at least the regeneration circuitry, or other elements within the repeater. Thus, at least one of the emitting and/or the sensing pixels comprises a harvesting LE transducer, and the repeater further comprises a power supply circuit for receiving power harvested from the harvesting LE transducer. Optionally, at least a portion of the harvested power is being retransmitted via at least one pixel. The power may be harvested by a photovoltaic transducer in the emitting or sensing pixel, or in both pixels.

The CRTR based interface, acting as receiver or as a transmitter, may be utilized with single mode or with multi-mode fibers, however with multimode fibers using a plurality of pixels coupled to a single fiber may be advantageous in certain applications. Furthermore, if a plurality of transducers are feeding a plurality of signals respectively into the fiber, each with its own spectral component, the device would act as a multiplexer. Conversely if the fiber is feeding a plurality of spectral components containing signals, to a respective plurality of transducers, the device would act as a de-multiplexer.

In an aspect of the invention there is provided an optical fiber interface comprising a tapered waveguide core having a first end and a second end, the first end defining an aperture, the core having a depth direction extending between the first end and the second end, wherein the depth magnitude increases with distance from the first end toward the second end; the core having a monotonically decreasing width dimension in at least one direction transverse to the depth direction. A cladding is disposed at least partially around the core, at least one transducers disposed about the cladding; and, an aligner disposed to facilitate aligning the optical fiber with the aperture of the pixel.

Optionally the at least one transducer is an LE type transducer for converting radiant energy received in the core from the optical fiber into electrical energy. Alternatively and/or additionally the transducer is an EL type transducer, for receiving an electrical signal and coupling it via the cladding and the tapered core, into the fiber. Combinations of more transducers of either type are also supported, such that by way of example, at least one transducer is a LE type transducer, and further comprising at least a second transducer disposed about the cladding, the second transducer being an EL type transducer.

Further optionally the tapered core has a depression formed therein.

Optionally the optical fiber interface further comprises a second transducer disposed about the cladding, for harvesting or transmitting radiant energy via the optical fiber.

In another aspect of the invention there is provided an optical fiber signal repeater comprising a receiver comprising a tapered waveguide core having a first end and a second end, the first end defining an aperture, the core having a depth direction extending between the first end and the second end, wherein the depth magnitude increases with distance from the first end toward the second end; the core having a monotonically decreasing width dimension in at least one direction transverse to the depth direction. A cladding is disposed at least partially around the core. At least one LE type transducer is disposed about the cladding.

The repeater also comprises a transmitter having a tapered waveguide core having a first end and a second end, the first end defining an aperture, the core having a depth direction extending between the first end and the second end, wherein the depth magnitude increases with distance from the first end toward the second end; the core having a monotonically decreasing width dimension in at least one direction transverse to the depth direction. A cladding is disposed at least partially around the core. At least one EL type transducer disposed about the cladding.

The minimal set of the repeater is completed by signal regeneration circuitry which is coupled between the transmitter and the receiver, for regenerating signals detected by the receiver, and retransmitting the regenerated signal via the transmitter.

Optionally, the repeater further comprises an energy harvesting transducer disposed the cladding in the receiver or in the transmitter; and a power supply circuit coupled to the energy harvesting transducer. Further optionally, at least a portion of the harvested power is being retransmitted via the transmitter or the receiver.

Optionally at least one of the transducers is a laser transducer.

In certain optional embodiments, the transmitter, the receiver, or both, further comprise lateral waveguides disposed at least partially about the cladding, wherein at least one of the transducers is disposed within the lateral waveguides.

### BRIEF DESCRIPTION OF THE DRAWINGS

The summary, above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a simplified view of a CRTR.

FIG. 2 depicts four schematic symbols for CRTRs operating in different modes.

FIG. 3 depicts a simplified diagram of an optical fiber transmitter.

FIG. 4 depicts a simplified diagram of an optical fiber repeater, showing optional power arrangement.

FIG. 5 depicts some optional features of a CRTR used in either the fiber transmitter and/or the repeater.

FIG. 6 depicts an emitting pixel.

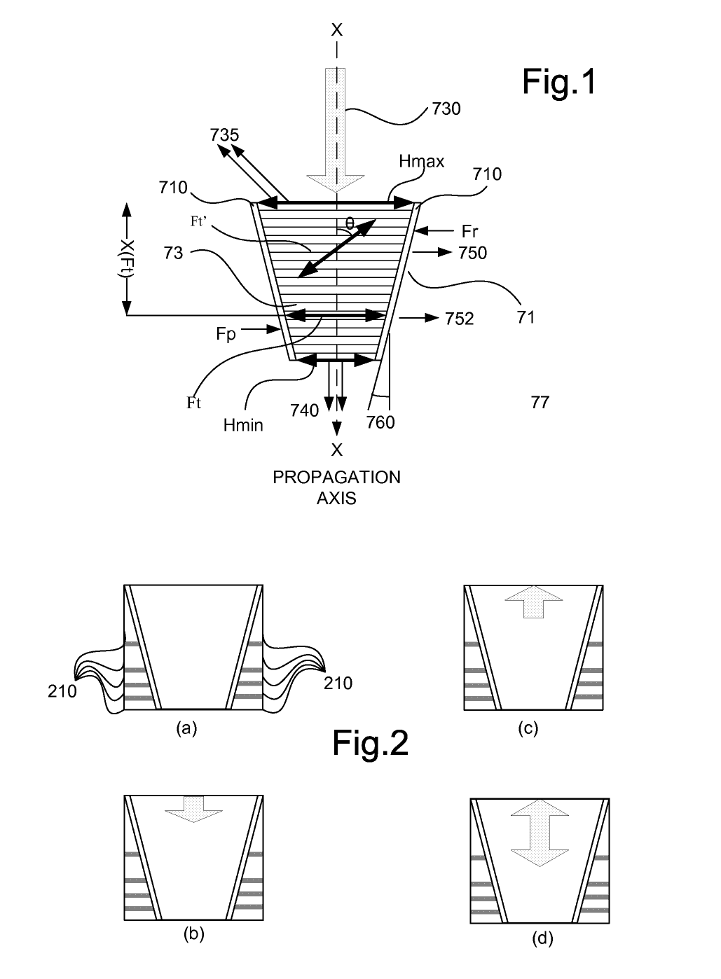

### DETAILED DESCRIPTION

Certain figures and embodiments of the invention will now be described by way of example to increase the understanding of different aspects of the invention.

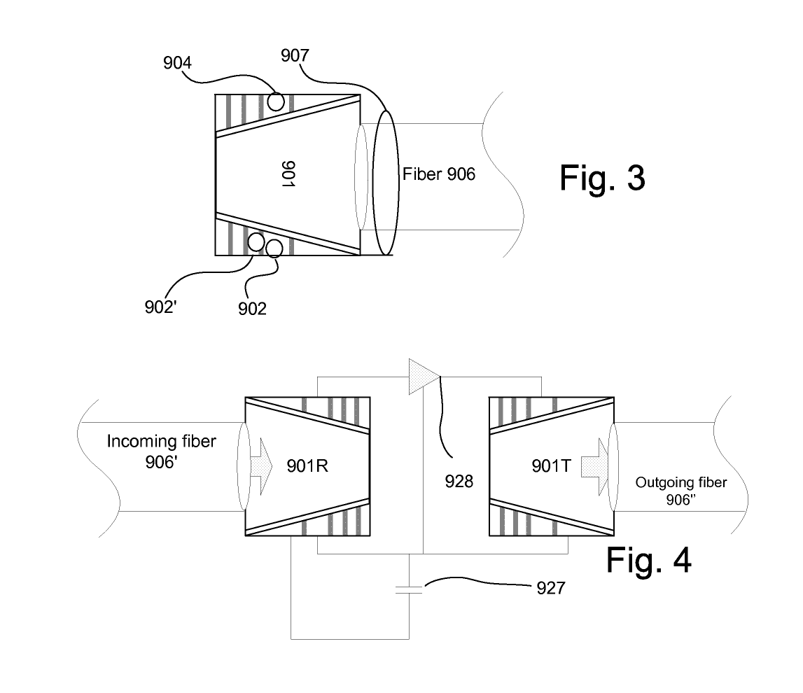

FIG. 3 depicts an improved interface to an optical fiber. An EL transducer 902 is coupled to a CRTR 901 and injects a signal via the cladding into the CRTR tapered core. Alternatively an LE transducer 904 may also be placed to receive incoming signals from the fiber. Interface devices may be transmitting only, receiving only, or a combination thereof. In receiving only interface devices the CRTRs operate in splitter mode and the data transducers are LE type, while in transmitting only the CRTR operates in mixer/combiner mode, and the transducers are of EL type. In combined embodiments, both types of transducers are used. Therefore the transducer is directed at inter-converting between an electrical signal and a radiant energy, weather it is a unidirectional transducer such as an LE or an EL, or a combined transducer capable of acting both as an EL or an LE type transducer.

If desired, a plurality of transducers may be coupled to the CRTR. The transducer operates as channelized reversible filter for differing frequencies. Thus, by way of example, EL transducer 902′ may be coupled and operate at different frequency, turning the CRTR based pixel into a multiplexer. If a plurality of LE transducers is also provided in a similar manner (not shown) the optical fiber interface will become a multiplexer/demultiplexer.

A fiber 906 is coupled to the aperture of the CRTR tapered core. The transducer is coupled to a data stream. Commonly, but not necessarily the transducer comprises a laser. A plurality of transducers may be arranged about a single CRTR if desired, to multiplex more than one data stream into the fiber. Fiber 906 is coupled to the CRTR core at the aperture. The CRTR based optical fiber interface is adapted to receive the fiber by having an aligner 907 which facilitates alignment of the fiber and the aperture. The aligner may be any support structure such as a ring, a tube, a number of aligned holes, adhesive, or any other mechanical structure including enclosures which will hold the fiber aligned to the aperture. In certain embodiments a depression 911 is formed in the tapered core material, to ease alignment of the fiber to the CRTR core.

Yet a farther alternative is to utilize a relatively high power laser to provide energy to the fiber, for harvesting the energy by downstream devices. In certain embodiments the data signal or a portion thereof is carried by the high power laser, while in most embodiments the information is provided by a different transducer.

When light travels through a fiber, it slowly disperses, i.e. the square pulse that is fed into the fiber slowly stretches and loses the homogeneity it first had. This limits the distance that signal may travel in a fiber, and requires ‘refreshing’ every so often.

Increasing the transmission power of the data does not provide a solution to the dispersion problem, as the problem stems from the fact that light of differing frequency and polarization travels at different speeds through the fiber medium. Furthermore, current technology transducers of data signals in the fiber are saturated by high energy signals and lose their ability to detect data. Therefore there is a need for repeaters disposed at intervals along a long data carrying optical fiber, for regenerating the data pulses.

Therefore, an aspect of the invention is a CRTR based repeater for optical fibers, constructed to receive a data signal in the fiber before it is dispersed to the point that will diminish the ability to decode the data signal, regenerating the signal, and transmitting it to another fiber. Due to the high power handling of the CRTR such repeater can be powered by optical energy carried within the fiber. FIG. 4 represents a simplified diagram of one type of a CRTR based repeater.

As seen in FIG. 4, receiving CRTR 901R accepts a signal from the incoming optical fiber 906′. Receiving CRTR 901R operates in splitter or in a hybrid mode. The signal is fed to regeneration circuitry 928, which regenerates the data and feeds it to transmitting CRTR 901T, for retransmission into the outgoing optical fiber 906″. Regeneration circuitry 928 may be a simple threshold based circuitry, or digital circuitry to receive and resolve the data signals, and generate new signals corresponding thereto. Transmitting CRTR 901T operates in combiner mode or in hybrid mode to transmit the reconstructed signal through the outgoing fiber 906″.

The repeater may utilize a local power supply, however optionally, power may be fed via the incoming or the outgoing fibers. As discussed in relation to the embodiment relating to FIG. 3, a high powered laser may couple energy to a fiber. A CRTR may harvest sufficient power for the operation of a repeater from energy communicated by the fiber, and use the energy to regenerate the signal, discarding the dispersion. Furthermore, excess energy may be transmitted into an outgoing fiber, together with the regenerated signal, for use by other repeaters downstream.

Therefore, FIG. 4 depicts an optional improvement to the optical fiber repeater, where energy is supplied via the optical fiber and harvested by a CRTR. While the drawing depicts energy arriving via the incoming fiber, the energy may also be transmitted via the outgoing fiber. The energy is harvested by one or more LE transducers coupled to CRTR 901R, and or 901T. The energy may be coupled to the energy carrying fiber at the remote end by any desired manner, such as by way of example, by the improved fiber interface described above, by optical mixers, by another repeater, and the like.

While both the signal and the harvested energy may be of the same spectral component and a single transducer may be utilized for both harvesting and data detection, it is desirable to separate the two. Therefore, optionally, energy for harvesting and powering the repeater and downstream equipment is provided in a first spectral component, and the data carrying signal is provided in a second spectral component.

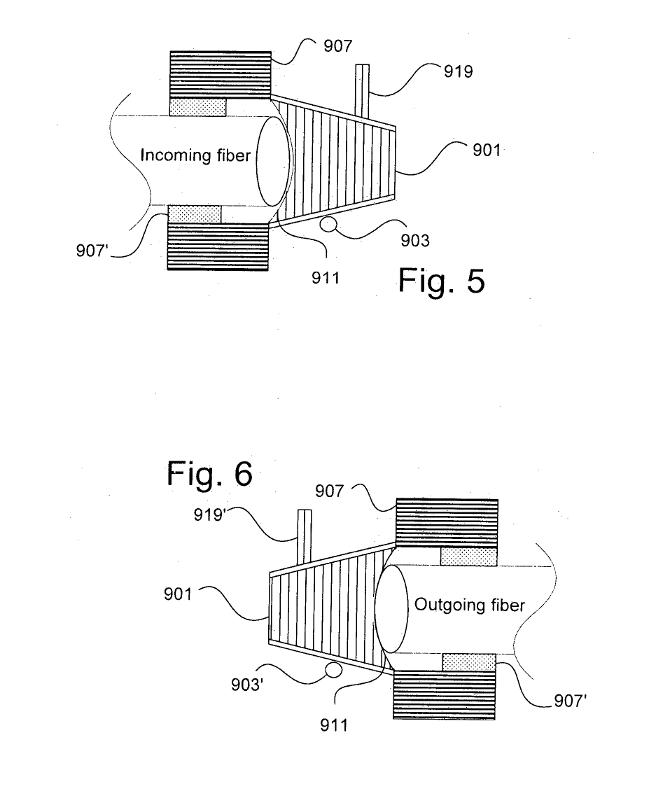

Signals arriving by the incoming optical fiber are fed to receiving CRTR 901R, which is shown in greater detail on FIG. 5, which is a depiction of CRTR based pixel arranged as a sensing pixel. The CRTR 901 based pixel has at least one signal LE transducer 903, and optionally a plurality thereof. The converted signal is coupled a regenerating circuitry, the output of the regenerating circuitry is coupled to transmitting CRTR 901T, in a similar manner to the CRTR fiber interface as described in relation to FIG. 3. Transmitting CRTR is shown in more details in FIG. 6, where transducer 903′ is an EL type transducer.

Optionally energy is delivered via the incoming optical fiber, the outgoing optical fiber, or both, and the delivered energy or a portion thereof is harvested by at least one harvesting transducer coupled to a corresponding CRTR. At least a portion of the energy may be utilized for operating the repeater, or portions thereof. Further optionally, the remaining harvested energy is also coupled to the transmitting CRTR 901T, and in such embodiments, separating the power from the signal is desired, and thus a harvesting transducer operating at a different portion of the spectrum from the data is utilized.

Notably, while the repeater depicted in FIG. 4 is described in unidirectional mode of operation, utilizing CRTRs operating in hybrid mode the repeater operation will become bidirectional. Similarly, operational energy to be harvested may equivalently be provided via the outgoing fiber.

FIGS. 5 and 6 are utilized to show several optional features in both the receiving and the transmitting CRTR's for use with an optical fiber repeater and/or interface. FIG. 5 depicts a CRTR based sensing pixel and FIG. 6 depicts an emitting pixel. The CRTR 901 has at least one LE transducer 903 disposed about the cladding. The figures also depict several other optional embodiments. By way of example, PV transducer 919 is also coupled to the CRTR, and is utilized to harvest energy for the use of a repeater, by way of example. PV transducer 919 may be employed in either the sensing or the emitting pixels. Transducer 919′ is a transmitter transducer capable of applying energy to the fiber for use by downstream devices.

FIGS. 5 and 6 also depict an optional construction feature where the aperture of the CRTR is formed as a depression 911 to facilitate aligning and reduced potential mismatch between the fiber and the core. Yet another optional feature is formed by aligners 907 and 907′. This embodiment of the aligner utilizes retaining walls 907 which are coupled to the CRTR. Optionally a sealant 907′ is also applied to retain the fiber in place.

Therefore in an aspect of the invention there is provided a CRTR based fiber data repeater, the repeater comprising a first CRTR having an aperture, at least one LE transducer coupled to the CRTR and disposed to receive a spectral component emitted via the first CRTR cladding, a pulse shaping circuitry, and a second CRTR having an aperture and at least one EL transducer coupled thereto via the cladding, the pulse shaping circuit having an input coupled to the at least one LE transducer and the output of the pulse shaping circuitry being coupled to the EL transducer. In common embodiments the first and second CRTR aperture are each constructed to interface with a fiber.

Optionally, the first LE transducer is constructed to harvest energy from an incoming fiber coupled to the first CRTR. In another optional embodiment a second LE transducer is coupled to the first or second CRTRs to harvest energy from an incoming or outgoing fiber, at least a portion of the harvested energy being utilized for energizing the repeater or portions thereof. In certain embodiments a portion of the harvested energy is coupled to a transducer coupled to the first or the second CRTR for transmission thereby. Clearly, if the energy is harvested in the first CRTR it is coupled to the second CRTR for further transmission, and vice versa.

As described above, CRTRs are commonly disposed within stratum which may comprise a slab or a plurality of superimposed waveguides known as lateral waveguides. Layers and portions of the stratum may be formed as a single undivided layer, or may be divided into sections. Sections may be separated electrically and/or optically, and the barriers between the different sections will generally be referred to hereinunder as “baffles”. A common division is to provide baffles to separate the region around a single CRTR and thus create a single CRTR pixel; however, divisions containing more than one CRTR may exist as desired. A pixel may be an emitting pixel, a sensing/harvesting pixel, or a combination thereof. The stratum may also comprise circuitry such as conductors, vias, and the like as required for connecting individual pixels. The stratum may also contain active and passive electronic components, such as amplifiers, controllers, switches, and the like. In certain embodiments the stratum may comprise inactive layers.

The stratum material is a matter of technical choice; however, good reproducibility of its index of refraction, capability of being deposited at sub-micron to micron-scale thicknesses with good uniformity, precise thickness control, and low stress are highly desired, as are good adhesion to the substrate and compatible thermal properties. Spin on glasses, such as polymethylsiloxanes, polymers such as polymethylmethacrylate (PMMA) and parylene, oxides and nitrides, such as silicon-aluminum oxy-nitride (SiₐAl_{b}O_{c}N_{d}, including Sialon®) and the like are all potential stratum material. The skilled in the art would recognize many other well-known materials providing the desired properties.

The cladding of CRTRs and/or the stacked waveguides may comprise a plurality of materials and may be deposited in several stages. Aluminum, silver, copper, and gold are among the many candidate metals that are highly reflective, electrically efficient and chemically stable, although numerous other examples are readily considered. At optical frequencies the skin depth is on the order of 1-5 nm and thicknesses of continuous metallic claddings may be on or below this order. Use of metallic claddings imposes few constraints on the core material other than thermal compatibility and transparency over the spectral range of interest. Some metals form discontinuous films on some substrates even at thicknesses in excess of the skin depth. Such discontinuous (porous or perforated) metal films are also known to be semi-transparent near normal incidence at thicknesses approaching tens of nm, and such discontinuous metal cladding is also considered. Cladding may also be a low retractive index dielectric material, polymers, and the like. Silicon dioxide, Parylene-N, are but two possible candidates for cladding materials.

Efficient total internal reflection of the light in the CRTR core suggests that the core have higher refractive index than the cladding and that the cladding have a minimum thickness sufficient to totally internally reflect the wave until approximately the critical angle, at which a cladding penetration state is abruptly reached.

At wavelengths from about 3.5 μm to about 20 μm rectennas and other plasmonic direct detection schemes are promising. In this band the frequencies are theoretically compatible with atomic layer deposition (ALD) MI2M tunnel diodes and there are plausible fabrication methods for 1.5 to 10 μm long nanowires electrically attached to the lower metallic surface of a lateral waveguide and atomic-layer spaced from the subsequent layer. Such nanowires would form a λ/2 “inside-out” dipole in which the feed points are low impedance nodes of the antenna resonance, one attached to a ground plane and one connected by a tunnel diode to a signal trace within a collector. Small arrays of such rectennas surrounding the CRTR at the appropriate depth in the substrate offer relatively wide dynamic range transducers at frequencies below the RC time constant cutoff of the tunnel diodes. Multiple layers of such small arrays at different center frequencies could be built for multi-spectral IR imaging. Rectennas are also especially fit for harvesting energy in the IR range and will provide excellent results when deployed to recover waste hit such as from inside chimneys, around boilers, exhaust pipes, etc.

HgCdTe is able to detect a wide range of infrared radiation and thus presents an option for certain classes of sensors for at least some layers of a CRTR based lateral waveguides based sensing pixel. The cooling requirements for HgCdTe is expensive in the LWIR range and here rectennas may offer the better alternative. MWIR HgCdTe cameras can be operated at temperatures accessible to thermoelectric coolers with a small performance penalty. However, in many applications this is also undesirable and improved MIM tunnel diodes are therefore considered.

Photodiodes can be used as sensing elements and implemented in the lateral waveguide layers using amorphous or polycrystalline silicon, germanium, indium gallium arsenide, and the like. Combined with the filtering inherent to the CRTR, these layers of transducers are able to detect from the lowest wavelength SWIR all the way to UV. The sensing elements may be biased as desired, including utilizing black current or avalanche mode, according to the application requirements. In some cases, transistors can also be implemented in these layers. Thin film transistor active pixel sensor (TFT APS) with pixels ranging from 127 μm to tens of μm. More preferably, the sensing elements will be located in the thin film layers between pixels and the amplification and switching transistors will be of much smaller dimensions in a suitable high-quality layer above or below the pixel array.

Circuit elements such as power supply, biasing, amplification, and the like deemed non-essential for understanding the principles of operation of the various aspects of the invention have been omitted from the drawings but will be clear to the skilled in the art.

Many more options for the transducers abound, such as Si bolometers, quantum dots, and the like. Dye sensitized semiconductors and organic PV materials are also optional. It is important to note that transducers/transducers for such sensors may be deployed with or without the lateral waveguides.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

We claim:

1. An optical fiber interface comprising:
a tapered waveguide core having a first end and a second end, the first end defining an aperture, the core having a depth direction extending between the first end and the second end, wherein the depth magnitude increases with distance from the first end toward the second end;
the core having a monotonically decreasing width dimension in at least one direction transverse to the depth direction;
a cladding disposed at least partially around the core; and,
at least one transducers disposed about the cladding; and,
an aligner disposed to facilitate aligning the optical fiber with the aperture of the tapered waveguide core.

2. An optical fiber interface as claimed in claim 1, wherein the at least one transducer is an LE type transducer for converting radiant energy received in the core from the optical fiber into electrical energy.

3. An optical fiber interface as claimed in claim 1, wherein the transducer is an EL type transducer, for receiving an electrical signal and coupling it via the cladding and the tapered core, into the fiber.

4. An optical fiber interface as claimed in claim 1, wherein the aperture has a depression formed therein.

5. An optical fiber interface as claimed in claim 1, further comprising a second transducer disposed about the cladding, for harvesting or transmitting radiant energy via the optical fiber.

6. An optical fiber interface as claimed in claim 1, wherein the at least one transducer is a LE type transducer, and further comprising at least a second transducer disposed about the cladding, the second transducer being an EL type transducer.

7. An optical fiber interface as claimed in claim 1, wherein the at least one transducer is an EL type transducer, the interface comprising at least one additional EL type transducer disposed about the cladding for injecting a spectral component thereto, wherein spectral components from the first and second EL transducers are to be mixed within the tapered core, and coupled to the optical fiber.

8. An optical fiber interface as claimed in claim 1, wherein the at least one transducer is an LE type transducer, the interface comprising at least one additional LE type transducer disposed about the cladding for receiving a spectral component therefrom, wherein spectral components coupled to the tapered core from the optical fibers are separated and fed to corresponding transducers.

9. An optical fiber signal repeater comprising:
a receiver comprising a tapered waveguide core having a first end and a second end, the first end defining an aperture, the core having a depth direction extending between the first end and the second end, wherein the depth magnitude increases with distance from the first end toward the second end;
the core having a monotonically decreasing width dimension in at least one direction transverse to the depth direction;
a cladding disposed at least partially around the core; and,
at least one LE type transducer disposed about the cladding;
a transmitter comprising a tapered waveguide core having a first end and a second end, the first end defining an aperture, the core having a depth direction extending between the first end and the second end, wherein the depth magnitude increases with distance from the first end toward the second end;
the core having a monotonically decreasing width dimension in at least one direction transverse to the depth direction;
a cladding disposed at least partially around the core; and,
at least one EL type transducer disposed about the cladding; and,
a signal regeneration circuitry coupled between the transmitter and the receiver, for regenerating signals detected by the receiver, and retransmitting the regenerated signal via the transmitter.

10. An optical fiber signal repeater as claimed in claim 9, further comprising:
an energy harvesting transducer disposed the cladding in the receiver or in the transmitter; and,
a power supply circuit coupled to the energy harvesting transducer.

11. An optical fiber signal repeater as claimed in claim 10, wherein at least a portion of the energy harvested from the energy harvesting transducer is being retransmitted via the transmitter or the receiver.

12. An optical fiber signal repeater as claimed in claim 9, wherein at least one of the transducers is a laser source;

13. An optical fiber signal repeater as claimed in claim 9, wherein the transmitter, the receiver, or both, further comprise lateral waveguides disposed at least partially about the cladding, and wherein at least one of the transducers is disposed within the lateral waveguides.

14. An optical fiber signal repeater as claimed in claim 9, wherein the aperture in the transmitter or receiver has a depression formed therein.

15. An optical fiber signal repeater as claimed in claim 9, wherein at least one of the transducers is a laser transducer.

16. An optical fiber signal repeater as claimed in claim 9, wherein the receiver further comprises at least one EL type transducer for operability as a transmitter as well as a transmitter.

17. An optical fiber signal repeater as claimed in claim 9, wherein the transmitter further comprises at least one LE type transducer for operability as receiver as well as a transmitter.
